(19) United States
(12) Patent Application Publication
(10) Pub. No.: US 2013/0107500 A1
(43) Pub. Date: May 2, 2013

(54) LIGHTED GLOVE APPARATUS AND SYSTEM

(71) Applicants: Matthew D. Noble, Los Angeles, CA (US); Ron A. Pickens, Owasso, OK (US)

(72) Inventors: Matthew D. Noble, Los Angeles, CA (US); Ron A. Pickens, Owasso, OK (US)

(21) Appl. No.: 13/285,054

(22) Filed: Oct. 31, 2011

(51) Int. Cl. F21V 21/08

(52) U.S. Cl. 362/103

(57) ABSTRACT

A lighting element for a glove includes a controller connected to a power source. A cuff lighting housing is connected to the controller. The cuff lighting housing is connected to a portion of a glove.

### BACKGROUND

1. Field

The embodiments relate to gloves, and in particular to gloves with lighting elements.

2. Description of the Related Art

Gloves are worn by users for a variety of reasons. Typically gloves are used for protection from the elements, protection from excessive force that would otherwise injure a user, or protective against scraping, abrasion and irritation.

### SUMMARY

One embodiment of the invention includes a lighting element for a glove includes a controller connected to a power source. A cuff lighting housing is connected to the controller. The cuff lighting housing is connected to a portion of a glove.

Another embodiment of the invention includes a glove comprises a glove body portion including a plurality of finger portions and a thumb portion. A cuff portion is connected to the body portion. A lighting housing is connected to the cuff portion. The lighting housing includes one or more lighting elements. A switch is connected to a power source and the one or more lighting elements.

Yet another embodiment of the invention provides a cuff for a glove. The cuff includes a controller connected to a power source. The controller is connected to a first portion of the cuff. A cuff lighting housing is connected to the controller. The cuff lighting housing is connected to a second portion of the cuff.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates a top view of a glove with a lighting element according to one embodiment of the invention;

FIG. 2 illustrates bottom view of the glove with a lighting element illustrated in FIG. 1 according to one embodiment of the invention;

FIG. 3 illustrates an isolated view of a lighting element for a glove according to one embodiment of the invention;

FIG. 4 illustrates a block diagram of a circuit for a lighting element according to one embodiment of the invention; and

FIG. 5 illustrates a block diagram of another circuit for a lighting element according to one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of lighting elements for gloves, as well as methods and/or component parts thereof. While the following description will be described in terms of lighting elements for gloves for clarity and to place the invention in context, it should be kept in mind that the teachings herein may have broad application to all types of systems, devices and applications.

One embodiment of the invention includes a lighting element for a glove includes a controller connected to a power source. A cuff lighting housing is connected to the controller. The cuff lighting housing is connected to a portion of a glove. By including a lighting element attached to a cuff portion of a glove, the lighting element is visible regardless of a user's hand position. The lighting on the cuff of a glove may be used for many purposes in low light or dark lit areas, including emergency services, road workers, airport workers, ship workers, team environments, safety of traffic control workers, bicycle riders, motorcycle riders, police agencies, towing personnel, rescue workers, location and identification of team members (e.g., for airport personnel, shipping personnel, team sports/entertainment, etc.), construction worker location and identification, etc.

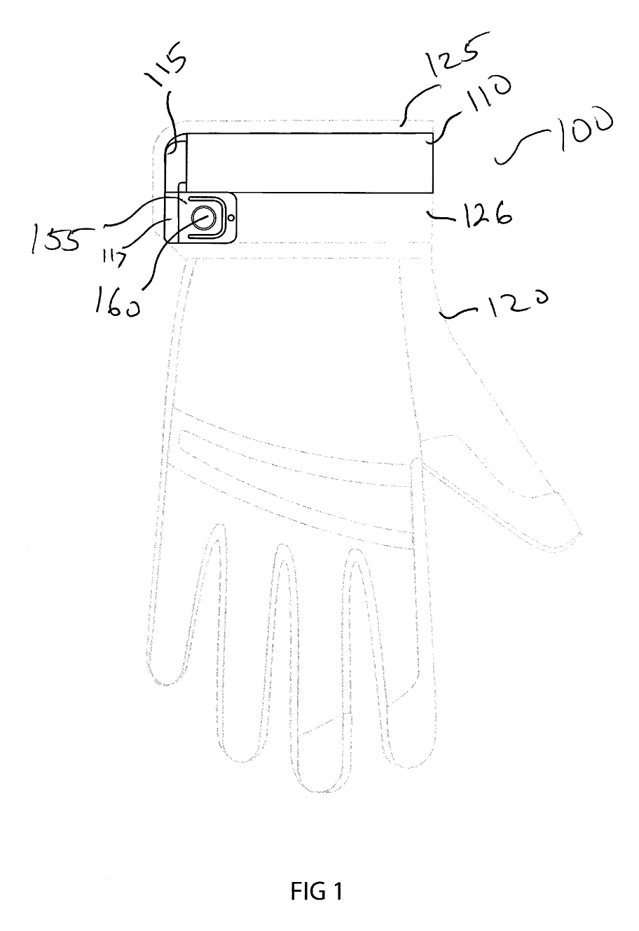

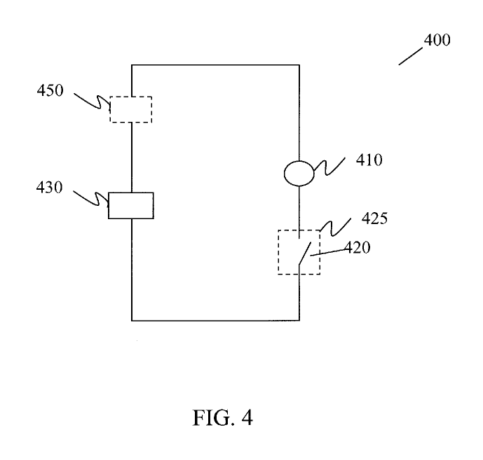

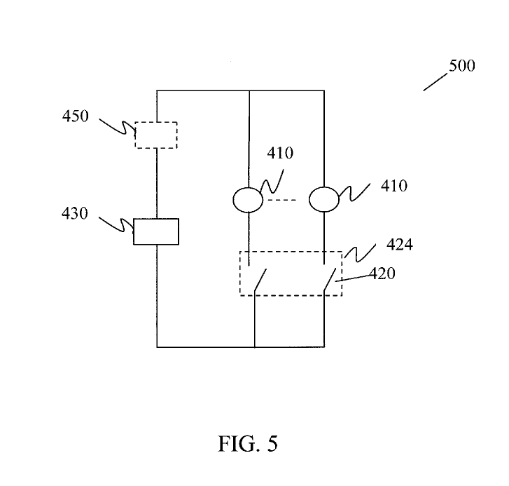

FIG. 1 illustrates a perspective view of a glove system 100 with a lighting element housing 110 according to one embodiment of the invention. In one example, the lighting element housing 110 is a tube or flat shaped conduit that acts as a lens for lighting elements 410 (FIG. 4/FIG. 5). In one embodiment of the invention, the glove 120 includes a cuff including an upper cuff portion 125 and a lower cuff portion 126. In one embodiment of the invention, the lighting element housing 110 is attached to the upper cuff portion 125. In one example, the lighting element housing 110 is attached to a lighting element controller 155 coupled with a wiring conduit 117 and a wiring conduit coupler 115. In one example, the lighting element controller 155 includes a control button or push switch 160 for controlling the lighting elements 410.

In one example, the lighting element controller 155 and lighting element housing 110 may be attached to the cuff including upper cuff portion 125 and lower cuff portion 126 via molding, welding, adhesives, stitching, snap-fitting, slide-fitting, etc. In one embodiment of the invention, the lighting element controller 155 may be incorporated with the lighting element housing 110. In another embodiment of the invention, the lighting element controller 155 may be detached from the glove 120. In one embodiment of the invention, the lighting element controller 155 may remotely control lighting elements 410 (FIG. 4/FIG. 5) via a radio frequency remote control, infrared remote control, etc. In one example, the lighting element controller 155 includes a toggle element (not shown) for controlling different functions of the lighting element controller, such as turning on/off lighting elements 410, selecting type of lighting (e.g., solid lighting, strobe lighting, color selection, etc.), etc.

In one example, the lighting element housing 110 may be made of protective material in order to protect the lighting elements 410. In one example, the lighting element housing 110 is made of a cushioned material, such as polyurethane, plastics, rubber, etc. In other examples, the lighting element housing 110 is made of a hardened material (e.g., hardened plastic, rubber, etc., or a combination of a hardened material and cushioned material.

In one example, the wiring conduit 117 and the wiring conduit coupler 115 may be made of vinyl, plastic, metal, metal alloy, etc. In one embodiment of the invention, the wiring conduit 117 may snap attach to the lighting element controller 155 and to the wiring conduit coupler 115. In other embodiments of the invention, the wiring conduit 117 may be permanently attached to the lighting element controller 155 and the wiring conduit coupler 115.

In one example, the upper cuff portion 125 and/or the lower cuff portion 126 may include a high-visibility, reflective or glow in the dark material to enhance the effect of emitted light from the lighting elements 410.

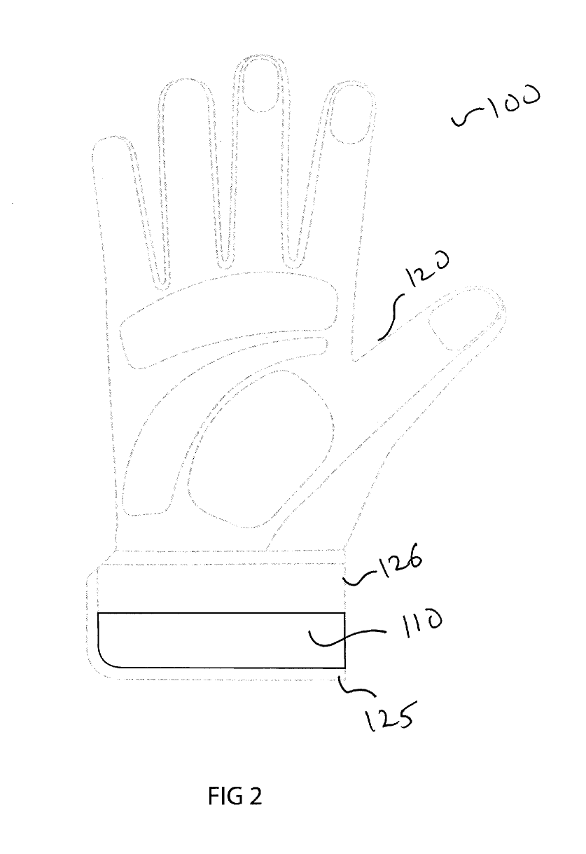

FIG. 2 illustrates a bottom view a system 100 including of a glove 120 attached with a lighting element housing 110 according to one embodiment of the invention. As shown, the lighting element housing 110 wraps around the upper cuff portion 125. In one embodiment of the invention, the lighting element housing 110 wraps completely around the cuff portion of the glove 120. In another embodiment of the invention, the lighting element housing 110 does not wrap completely around the cuff portion of the glove 120.

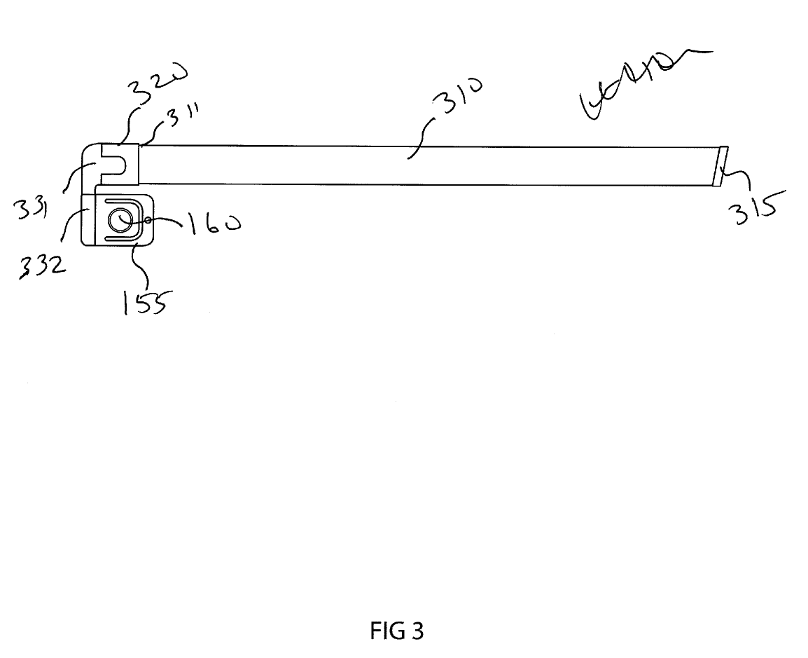

FIG. 3 illustrates a front view of an isolated lighting element housing 110 for the glove 120 according to one embodiment of the invention. In one embodiment of the invention, the lighting element housing 110 includes lighting element strip 310 including an end cap 315 and a portion 311 that connects to a connector portion 320 that is attached to the wiring conduit coupler 331 (similar to reference 115 in FIG. 1). The wiring conduit 332 (similar to reference 117 in FIG. 1) is connected to the wiring conduit coupler 331. In another example, the end cap 315 is protective to prevent moisture from entering the lighting element strip 310.

In one example, the lighting element strip 310 is translucent and may be clear, semi-clear, colored, etc. In another example, if a specific color is desired either portions of the lighting element strip 310 or the lighting elements 410 (FIG. 4/FIG. 5) may be the same color or may be colored differently. In one embodiment of the invention, the light element strip 310 and/or the lighting element housing 110 may be a lens for lighting elements 410.

In one embodiment of the invention, the lighting element controller 155 includes a protective housing to protect internal components from shock and abrasion. In one embodiment of the invention, the wiring conduit 117/332 includes a protective material to protect internal wires from compression and abrasion from normal use. It should be noted that other known equivalent materials may be used for the lighting element housing 110, lighting element controller housing, wiring conduit 117/332, wiring conduit coupler 115/331, such as high-density polyethylene, nylon material, hardened plastic, polymer, rubber, composite material, metal or metal alloy, etc.

In one embodiment of the invention the materials used for the various elements of glove 120 include, but are not limited to, spandex material, micro-fiber synthetic leather, leather (e.g., top grain, suede, etc.), neoprene, foam padding, polyurethane, PVC, nylon, polyester, canvas, etc.

FIG. 4 illustrates a circuit 400 for the lighting of the lighting element housing 110 according to one embodiment of the invention. In one embodiment of the invention, the circuit 400 for the lighting source of the lighting element housing 110 includes the lighting element 410, a switch 420 included in or operated by the lighting element controller 155, a power source 430 and optional sensor 450. In one example, the switch 420 may comprise a slide switch, a push button switch, a touch switch, remote control switch, etc. In one example, the switch 420 is switched from the top of the lighting element controller 155 via a control button or push switch 160.

In one embodiment of the invention, the lighting element 410 includes multiple light emitting diodes (LEDs) that emit lighting from within the lighting element housing 110. In one example, the LEDs of the lighting element 410 may comprise any combination of colored lighting, such as white, red, green, blue, yellow, infrared, etc. In other examples, other types of light sources may be employed with lighting element 410, such as Electroluminescent (EL) light sources, etc. In one example, the multiple LEDs may be connected in series, parallel or both.

In one embodiment of the invention, the switch 420 may comprise a user lighting selection functionality for controlling a desired light intensity from the lighting element 410 by means of a controller circuit 425. In one example, the switch 420 and controller circuit 425 may be user selectable to light only a portion of LEDs of the lighting element 410 (e.g., one, two, three, all, etc.). In another example, the switch 420 and controller circuit 425 may be user selectable to select a particular color of LEDs of the lighting element 410 (e.g., white, red, green, blue, yellow, etc.). In yet another example, the switch 420 and controller circuit 425 may be user selectable to select solid or blinking/strobe LEDs of the lighting element 410.

In one example, upon employing a light sensor as sensor 450, when the switch 420 is placed in an on position, the sensor 450 will not close the circuit 400 unless the sensor 450 senses that not enough light is within the proximity of the light sensor (i.e., the area is dark enough to necessitate lighting the area). In one example, the light sensor 450 may be positioned on the sides or front portions of the lighting element controller 155. In one example, employing the light sensor 450 provides energy saving when lighting the lighting source 410 is not necessary based on available ambient light. In one example, the light sensor 450 may be manually overridden. In one example, the sensor 450 may include any combination of sensors, such as motion and light sensors, position and light sensors, etc.

In one embodiment of the invention, the power source 430 comprises one or more rechargeable or non-rechargeable batteries selected based on the number of LEDs and/or voltage required to power the lighting element 410. In one example, a solar charging circuit is employed to store energy in a rechargeable battery of power source 430. In one example, the solar charging circuit may be disposed on the outer portion of the lighting element controller 155. In another example, an adapter or plug in socket may be employed with the lighting source circuit 400 to connect to an external power source, such as a battery pack from an electric tool (e.g., electric drill, hammer, screwdriver, etc.), separate additional battery pack, an AC/DC power supply, etc. Other examples may include multiple power sources 430 for extended lighting.

FIG. 5 illustrates a circuit 500 for the lighting of the lighting element housing 110 according to one embodiment of the invention. Circuit 500 is similar to circuit 400 except multiple switches and multiple lighting elements 410 1-N are employed, where N is a positive integer. In one example, the controller circuit 425 controls switches 420 1-N, where N is a positive number. In this example, the switches 420 1-N control whether power from the power source 430 is supplied to the lighting elements 410, where a number of lighting elements 410 may be employed, such as two, three, four, etc. In one example, a user that is part of a first team that is recognized with a first color would switch on lighting elements 410 with the specific color of the team. A next time the user uses a glove system 100 including the lighting element housing 110, they may be part of a team associated with a different color, therefore, the circuit 500 may be used to select the other lighting element 410 with the required color. Other examples include identifying a particular rank of an individual based on a desired color selected with the switches 420. Another example may include a particular pattern of colors or lights that may be selected. Yet another example may be switching to a different lighting element 410 based on an LED failure. In one example, multiple power sources 430 may be associated with particular switches 420.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A lighting element for a glove comprising:
a controller coupled to a power source;
a cuff lighting housing coupled to the controller,
wherein the cuff lighting housing is coupled to a portion of a glove.

2. The lighting element of claim 1, wherein the cuff lighting housing includes one or more lighting elements, and the one or more lighting elements emit light through the cuff lighting housing.

3. The lighting element of claim 1, wherein the controller comprises a multi-position switch coupled to the power source.

4. The lighting element of claim 3, wherein the multi-position switch includes a setting for solid and flashing light.

5. The lighting element of claim 3, wherein the cuff lighting housing includes a wiring conduit coupling element.

6. The lighting element of claim 3, wherein the cuff lighting housing is coupled to an upper cuff portion of the glove.

7. The lighting element of claim 6, wherein the cuff lighting housing is translucent.

8. The lighting element of claim 6, wherein the cuff lighting housing is coupled to an end cap portion.

9. The lighting element of claim 6, wherein the cuff lighting housing is coupled to a wiring conduit connector portion.

10. The lighting element of claim 9, wherein the controller is coupled to a wiring conduit, and the wiring conduit is coupled to the wiring conduit connector portion.

11. The lighting element of claim 2, wherein the controller selectively controls the one or more lighting elements.

12. A glove comprising:
a glove body portion including a plurality of finger portions and a thumb portion;
a cuff portion coupled to the body portion;
a lighting housing coupled to the cuff portion, the lighting housing comprising one or more lighting elements; and
a switch coupled to a power source and the one or more lighting elements.

13. The glove claim 12, wherein the lighting housing is coupled to a wiring conduit coupling element.

14. The glove of claim 12, wherein at least a portion of the lighting housing is translucent.

15. The glove of claim 14, wherein the switch is coupled to a first portion of the cuff portion and the lighting housing is coupled to a second portion of the cuff portion.

16. The glove of claim 15, wherein the switch includes a plurality of settings for controlling the one or more lighting elements.

17. A cuff for a glove, the cuff comprising:
a controller coupled to a power source, the controller coupled to a first portion of the cuff;
a cuff lighting housing coupled to the controller, the cuff lighting housing coupled to a second portion of the cuff.

18. The cuff of claim 17, wherein the cuff lighting housing includes one or more lighting elements, and the one or more lighting elements emit light through the cuff lighting housing.

19. The cuff of claim 18, wherein the controller comprises a switch coupled to the power source, wherein the switch includes one or more settings for controlling the one or more lighting elements.

20. The cuff of claim 19, wherein at least a portion of the lighting housing is translucent.
